(19) United States
(12) Patent Application Publication
(10) Pub. No.: US 2010/0220125 A1
(43) Pub. Date: Sep. 2, 2010

(54) DISPLAY APPARATUS AND DRIVING METHOD THEREOF

(75) Inventors: Feng-Sheng LIN, Tainan County (TW); Yu-Yeh CHEN, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/713,403

(22) Filed: Feb. 26, 2010

(30) Foreign Application Priority Data
Feb. 27, 2009 (TW) 098106600

(51) Int. Cl. G09G 5/02; G09G 5/00

(52) U.S. Cl. 345/694; 345/213

(57) ABSTRACT

A display apparatus for sequentially display images in accordance with first data and second data in successive first and second sub-frame times, respectively, includes at least one pixel, a light emitting module for emitting light to the pixel in the sub-frame times, and a driving module. The driving module includes a data conversion unit for outputting (i) a first driving signal based on at least the first data, and (ii) a second driving signal based on the first driving signal and the second data. The driving module further includes a driving unit for (i) driving the pixel in the first sub-frame time according to the first driving signal and (ii) driving the pixel in the second sub-frame time according to the second driving signal.

### CROSS REFERENCE TO RELATED APPLICATIONS

This Non-provisional application is based on and claims priority under 35 U.S.C. §119(a) from Patent Application No. 098106600 filed in Taiwan, Republic of China on Feb. 27, 2009, the entire content of which is hereby incorporated by reference.

### BACKGROUND

1. Technical Field

The disclosure relates to a display apparatus and a driving method thereof.

2. Related Art

Among currently available display apparatuses, liquid crystal display (LCD) apparatuses, having advantages such as low power consumption, low heat dissipation, light weight and non-radiation, are widely applied to various electronic products and gradually replace cathode ray tube (CRT) display apparatuses.

Referring to FIGS. 1 and 2, an LCD apparatus 1 known to the inventor(s) includes a pixel array 11, a driving module 12 and a backlight module 13. The driving module 12 can generate a driving signal corresponding to a grey value to drive molecules of the liquid crystal 111 of the pixel array 11 to rotate from an orientation R₁ to an orientation R₂. An unstable state period T₁₁ is the time period during which the liquid crystal 111 is in an unstable state due to the change from the orientation R₁ to the orientation R₂. Then, during a stable state period T₁₂ when the liquid crystal 111 is in a stable state at the orientation R₂, the backlight module 13 provides the pixel array 11 with sufficient light so that the LCD apparatus 1 can display correct images. That is, the backlight module 13 is turned on to provide the light just during the stable state period T₁₂. In other words, the LCD apparatus 1 can turn off the backlight module 13 during the unstable state period T₁₁, which can not only prevent incorrect images from being displayed due to the liquid crystal 111 being unstable during the unstable state period T₁₁, but also decrease the power consumption.

Besides, the pixel array 11 may require a color filter (CF) substrate (not shown in the figure) to display colored images. However, because the light provided by the backlight module 13 will pass through the pixel array 11 and the CF substrate, the image brightness of the LCD apparatus 1 may be lowered. To solve this problem, a color sequential driving method is known to the inventor(s) to drive the LCD apparatus. In the color sequential driving method, the backlight module 13 sequentially provides three colored light (such as red light, green light and blue light) in the three sub-frame times of a frame time, respectively. Therefore, the CF substrate can be omitted from the LCD apparatus 1, so as to enhance transmittance of the light and brightness of the LCD apparatus 1.

However, to shorten the unstable state period T₁₁, fast responsive liquid crystal 111 should be used in the LCD apparatus 1 which not only limits manufacturers' choice of liquid crystal material but also increase the cost of the LCD apparatus 1. Besides, because the backlight module 13 is turned on only during the stable state period T₁₂ to provide the light for the pixel array 11, utility rate of the backlight module 13 is limited greatly.

Therefore, it is desirable to provide a display apparatus and a driving method that can promote utility rate of the backlight module.

### SUMMARY

In an aspect, a display apparatus for sequentially display images in accordance with first data and second data in successive first and second sub-frame times, respectively, comprises at least one pixel, a light emitting module for emitting light to the pixel in the sub-frame times, and a driving module. The driving module includes a data conversion unit for outputting (i) a first driving signal based on at least the first data, and (ii) a second driving signal based on the first driving signal and the second data. The driving module further includes a driving unit for (i) driving the pixel in the first sub-frame time according to the first driving signal and (ii) driving the pixel in the second sub-frame time according to the second driving signal.

In a further aspect, a display apparatus for sequentially displaying a first image data and a second image data in a first frame time and a second frame time, respectively, is provided. The first image data and the second image data each at least have a first data and a second data, and the first frame time and the second frame time each at least have a first sub-frame time and a second sub-frame time corresponding to the respective first and second data, respectively. The apparatus comprises at least one pixel, a light emitting module, and a driving module. The light emitting module is configured for emitting a first colored light in each of the first sub-frame time, and emitting a second colored light differing from the first colored light in each of the second sub-frame time. The driving module comprises a data conversion unit for outputting a first driving signal and a second driving signal of the first image data according to the first data and the second data of the first image data, respectively, and outputting a first driving signal and a second driving signal of the second image data according to the first data and the second data of the second image data, respectively. The driving module further comprises a driving unit for driving the pixel in the first sub-frame time of the first frame time according to the first driving signal of the first image data, and driving the pixel in the second sub-frame time of the first frame time according to the second driving signal of the first image data, and driving the pixel in the first sub-frame time of the second frame time according to the first driving signal of the second image data, and driving the pixel in the second sub-frame time of the second frame time according to the second driving signal of the second image data. When the second data of the first image data substantially equals the second data of the second image data, and the first data of the first image data substantially differs from the first data of the second image data, the second driving signal of the first image data substantially differs from the second driving signal of the second image data.

In another aspect, a driving method of driving a display apparatus, which has at least one pixel, a light emitting module and a driving module, to sequentially display a first image data and a second image data in a first frame time and a second frame time, respectively, is provided. The first image data and the second image data each at least have a first data and a second data, the first frame time and the second frame time each at least have a first sub-frame time and a second sub-frame time corresponding to the respective first and second data, respectively. The driving module has a data conversion unit and a driving unit. The method comprises:

outputting a first driving signal and a second driving signal of the first image data according to the first data and the second data of the first image data, respectively, by the data conversion unit;

outputting a first driving signal and a second driving signal of the second image data according to the first data and the second data of the second image data, respectively, by the data conversion unit;

driving the pixel in the first sub-frame time of the first frame time according to the first driving signal of the first image data, and driving the pixel in the second sub-frame time of the first frame time according to the second driving signal of the first image data, by the driving unit; and

driving the pixel in the first sub-frame time of the second frame time according to the first driving signal of the second image data, and driving the pixel in the second sub-frame time of the second frame time according to the second driving signal of the second image data, by the driving unit,

wherein when the second data of the first image data substantially equals the second data of the second image data, and the first data of the first image data substantially differs from the first data of the second image data, the second driving signal of the first image data substantially differs from the second driving signal of the second image data.

In yet another aspect, a driving method of driving a display apparatus, which at least has a driving module, at least one pixel and a light emitting module, to display a first data in a first sub-frame time comprises:

controlling (i) a first transmittance curve of the pixel at least according to the first data and (ii) a first lighting time of the light emitting module in the first sub-frame time by the driving module, wherein the integral of the first transmittance curve over the first lighting time of the light emitting module in the first sub-frame time substantially equals the product of a first brightness corresponding to the first data and the first sub-frame time.

### BRIEF DESCRIPTION OF THE DRAWINGS

Embodiments of the invention will become more fully understood from the detailed description and accompanying drawings, which are given for illustration only, and thus are not limitative of the present invention, and wherein:

FIG. 1 is a block diagram that shows a known LCD apparatus;

FIG. 2 is a graph that shows liquid crystal orientation relating to time;

FIG. 3 is a flow chart that shows a driving method of a display apparatus according to a first embodiment of the invention, including steps S11 and S12;

FIG. 4 is a flow chart that shows the driving method of the display apparatus according to the first embodiment of the invention, wherein the step S11 includes steps S111 to S114;

FIG. 5 is a flow chart that shows the driving method of the display apparatus according to a modified configuration of the first embodiment of the invention, including steps S21 and S22;

FIG. 6 is a flow chart that shows the driving method of the display apparatus according to the modified configuration of the first embodiment of the invention, wherein the step S21 includes steps S211 to S216;

FIG. 7 is a schematic view that shows a grey value correction table for use in the driving method of the display apparatus in FIG. 6;

FIG. 8 is a graph that shows a transmittance curve and data relating to time;

FIG. 9 is a flow chart that shows a driving method of the display apparatus according to a second embodiment of the invention, wherein the step S21 includes steps S311 to S316;

FIG. 10 is a schematic view that shows a grey value correction table for use in the driving method of the display apparatus in FIG. 9;

FIG. 11 is a schematic view that shows a reference table for use in the driving method of the display apparatus in FIG. 9;

FIG. 12 is a flow chart that shows a driving method of the display apparatus according to a third embodiment of the invention, wherein the step S21 includes steps S411 to S416;

FIG. 13 is a schematic view that shows a set of grey value correction tables for use in the driving method of the display apparatus in FIG. 12;

FIG. 14 is a schematic view that shows a reference table for use in the driving method of the display apparatus in FIG. 12;

FIG. 15 is a schematic view that shows another set of grey value correction tables for use in the driving method of the display apparatus in FIG. 12;

FIG. 16 is a schematic view that shows another reference table for use in the driving method of the display apparatus in FIG. 12;

FIG. 17 is a table that shows the relationships among the data, the reference data, the driving signal and the grey value correction table(s); and

FIG. 18 is a block diagram that shows a display apparatus according to a fourth embodiment of the invention.

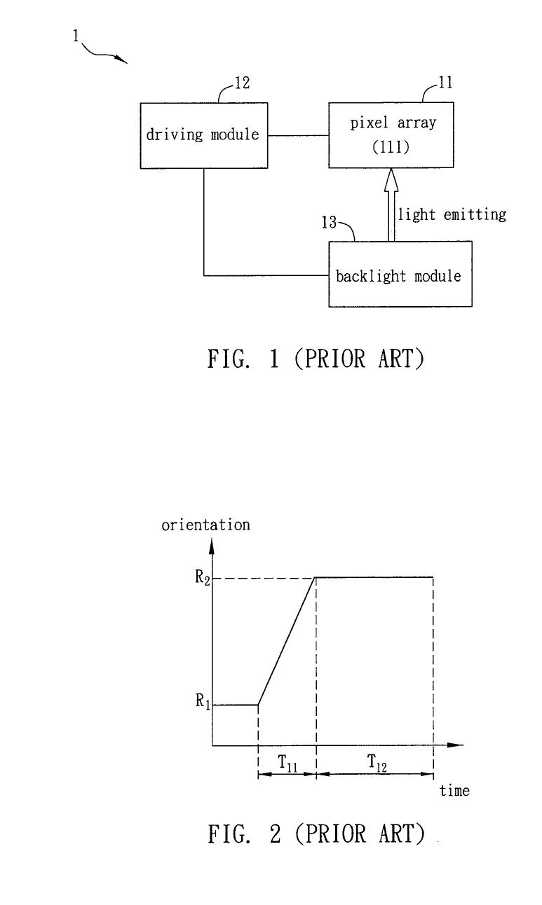

### DETAILED DESCRIPTION

Exemplary embodiments of the present invention will be apparent from the following detailed description, which proceeds with reference to the accompanying drawings, wherein the same references relate to the same elements.

### First Embodiment

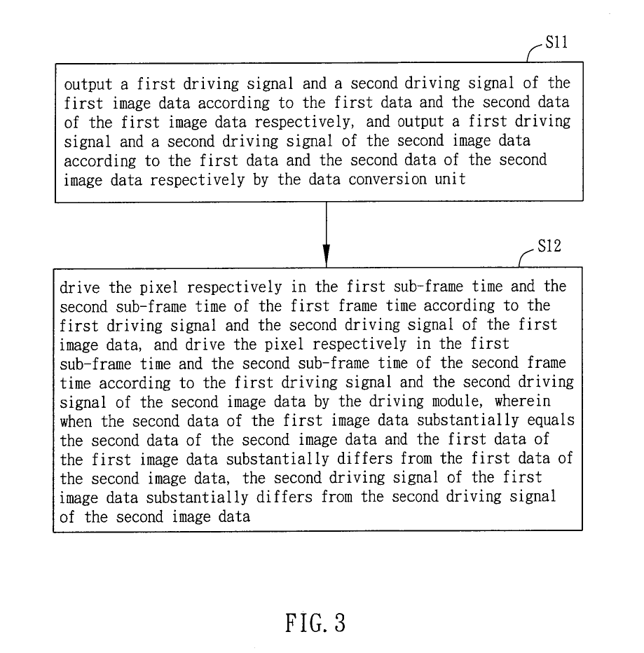

FIG. 3 is a flow chart that shows a driving method of a display apparatus according to the first embodiment. The display apparatus at least has a driving module, at least a pixel and a light emitting module. The driving module has a data conversion unit and a driving unit. The display apparatus sequentially receives a first data and a second data of the first image data and a first data and a second data of the second image data. The first image data and the second image data are sequentially inputted to the pixel in accordance with a color sequential driving method. The display apparatus, however, is not limited to the color sequential driving method.

As shown in FIG. 3, the driving method at least includes the steps S11 and S12. The step S11 is to output a first driving signal and a second driving signal of the first image data according to the first data and the second data of the first image data, respectively, and output a first driving signal and a second driving signal of the second image data according to the first data and the second data of the second image data, respectively, by the data conversion unit.

The step S12 is to drive the pixel respectively in the first sub-frame time and the second sub-frame time of the first frame time according to the first driving signal and the second driving signal of the first image data, and drive the pixel respectively in the first sub-frame time and the second sub-frame time of the second frame time according to the first driving signal and the second driving signal of the second image data by the driving module. Besides, when the second data of the first image data substantially equals the second data of the second image data and the first data of the first image data substantially differs from the first data of the second image data, the second driving signal of the first image data substantially differs from the second driving signal of the second image data.

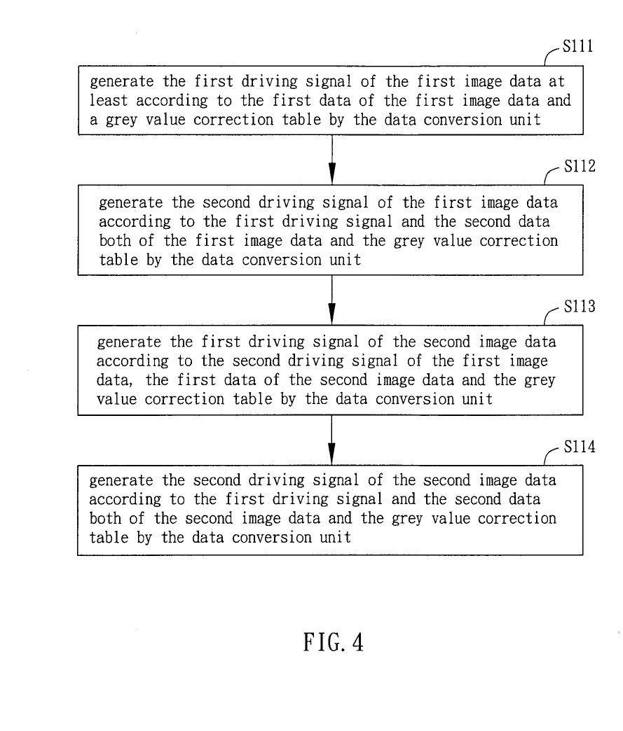

In detail, as shown in FIG. 4, the step S11 includes the steps S111 to S114. The step S111 is to generate the first driving signal of the first image data at least according to (i) the first data of the first image data and (ii) a grey value correction table by the data conversion unit.

The step S112 is to generate the second driving signal of the first image data according to (i) the first driving signal of the first image data, (ii) the second data of the first image data, and (iii) the grey value correction table by the data conversion unit.

The step S113 is to generate the first driving signal of the second image data according to (i) the second driving signal of the first image data, (ii) the first data of the second image data, and (iii) the grey value correction table by the data conversion unit.

The step S114 is to generate the second driving signal of the second image data according to (i) the first driving signal of the second image data, (ii) the second data of the second image data, and (iii) the grey value correction table by the data conversion unit.

The first data and the second data each represent a sub-grey value, for example, of red light, green light, blue light, white light, yellow light, cyan light or magenta light. Other colors are within the scope of this disclosure. Besides, the first data and the second data are sub-grey values of different colored light.

In a modified configuration of the first embodiment, besides the first data and the second data of the first image data, the display apparatus can sequentially receive a third data or more data of the first image data. Similarly, besides the first data and the second data of the second image data, the display apparatus can sequentially receive a third data or more data of the second image data. To give a clear illustration below, the display apparatus, for example, sequentially receives a first data, a second data and a third data of the first image data, and a first data, a second data and a third data of the second image data.

In the modified configuration of the first embodiment, the first data, the second data and the third data each represent a sub-grey value, for example, of red light, green light, blue light, white light, yellow light, cyan light or magenta light. Besides, the first data, the second data and the third data represent sub-grey values of different colored light. For example, the first data, the second data and the third data represent sub-grey values of red light, green light and blue light, respectively.

Besides, a first sub-frame time, a second sub-frame time and a third sub-frame time of the first frame time, and a first sub-frame time, a second sub-frame time and a third sub-frame time of the second frame time are sequential and correspond to the first data, the second data and the third data of the first image data, and the first data, the second data and the third data of the second image data, respectively.

The display apparatus can display according to the first data, the second data and the third data of the first image data, and the first data, the second data and the third data of the second image data in the first sub-frame time, the second sub-frame time and the third sub-frame time of the first frame time, and in the first sub-frame time, the second sub-frame time and the third sub-frame time of the second frame time, respectively.

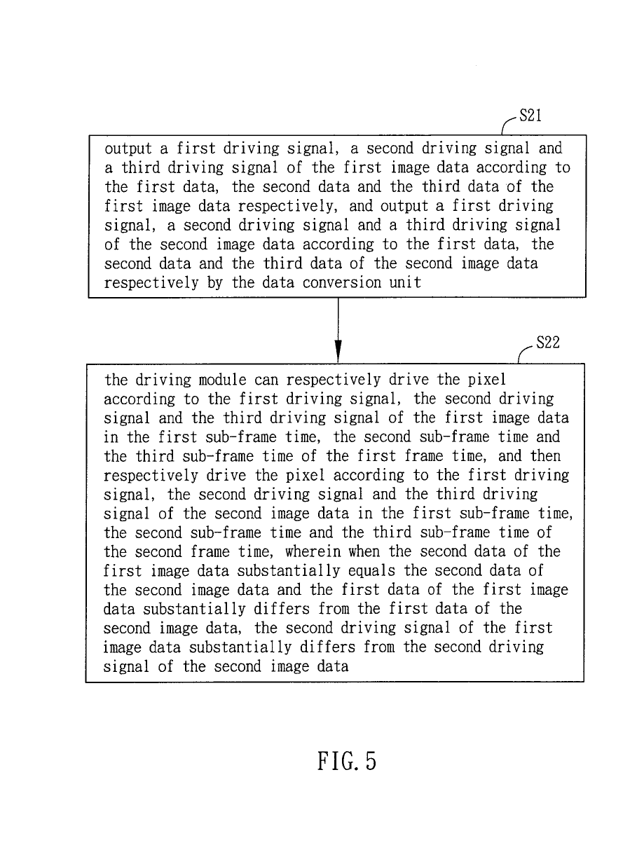

As shown in FIG. 5, the driving method of the display apparatus according to the modified configuration of the first embodiment at least includes the steps S21 and S22. The step S21 is to output a first driving signal, a second driving signal and a third driving signal of the first image data according to the first data, the second data and the third data of the first image data, respectively, and output a first driving signal, a second driving signal and a third driving signal of the second image data according to the first data, the second data and the third data of the second image data, respectively, by the data conversion unit.

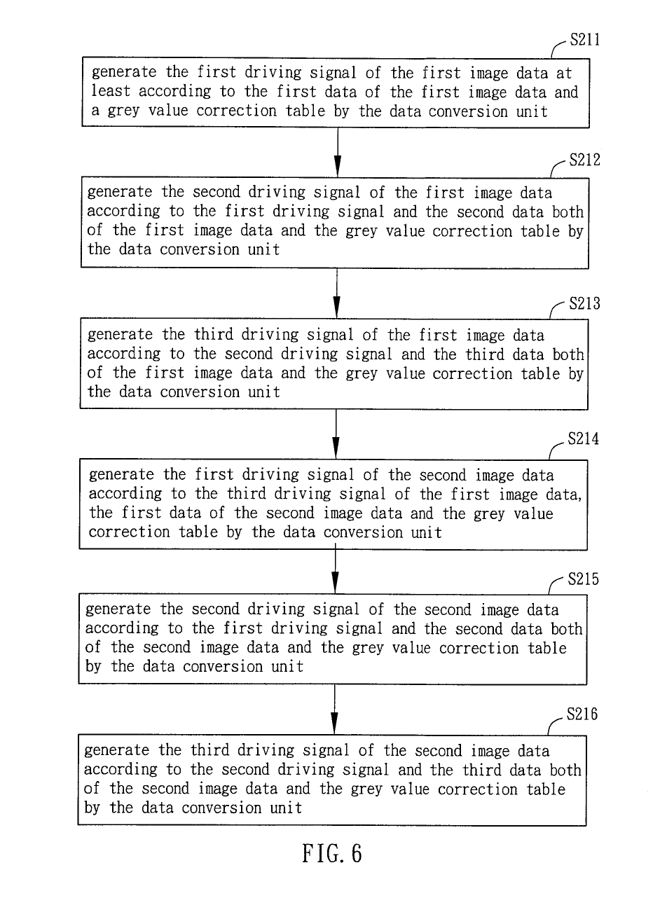

In detail, as shown in FIG. 6, the step S21 includes the steps S211 to S216. The step S211 is to generate the first driving signal of the first image data at least according to (i) the first data of the first image data and (ii) a grey value correction table by the data conversion unit.

The step S212 is to generate the second driving signal of the first image data according to (i) the first driving signal of the first image data, (ii) the second data of the first image data, and (iii) the grey value correction table by the data conversion unit.

The step S213 is to generate the third driving signal of the first image data according to (i) the second driving signal of the first image data, (ii) the third data of the first image data, and (iii) the grey value correction table by the data conversion unit.

The step S214 is to generate the first driving signal of the second image data according to (i) the third driving signal of the first image data, (ii) the first data of the second image data, and (iii) the grey value correction table by the data conversion unit.

The step S215 is to generate the second driving signal of the second image data according to (i) the first driving signal of the second image data, (ii) the second data of the second image data, and (iii) the grey value correction table by the data conversion unit.

The step S216 is to generate the third driving signal of the second image data according to (i) the second driving signal of the second image data, (ii) the third data of the second image data, and (iii) the grey value correction table by the data conversion unit.

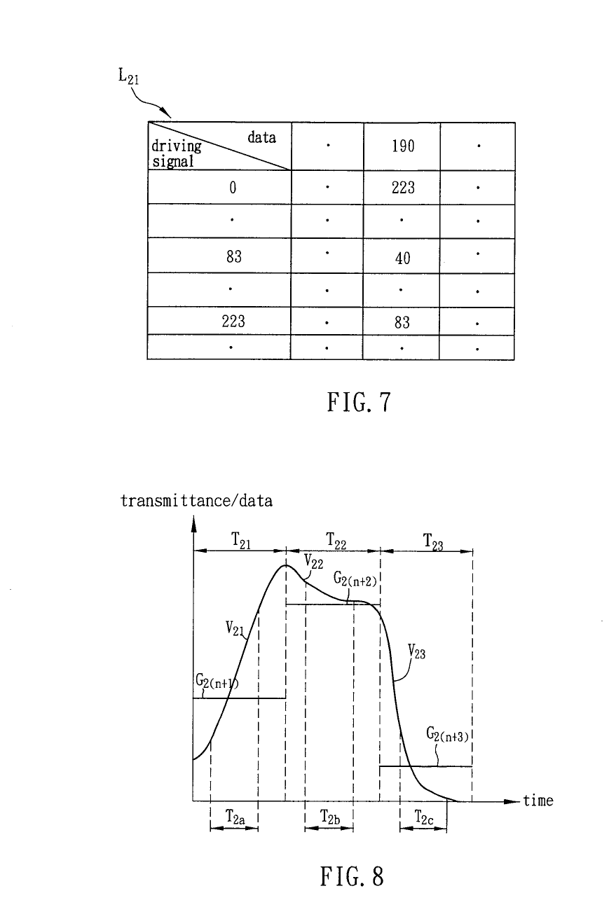

As shown in FIG. 7, for example, the first data, the second data and the third data of the first image data are represented by 190, 190 and 190, respectively, and zero is set as an initial value. First, according to the grey value correction table L₂₁, the value 233, as the first driving signal of the first image data, is derived from the initial value (zero) and the first data (190). Second, according to the grey value correction table L₂₁, the value 83, as the second driving signal of the first image data, is derived from the first driving signal (233) and the second data (190). Third, according to the grey value correction table L₂₁, the value 40, as the third driving signal of the first image data, is derived from second driving signal (83) and the third data (190).

Besides, the first driving signal, the second signal and the third driving signal of the second image data can be derived in the same principle as mentioned above, so the detail description is omitted here.

Accordingly, each of the driving signals derived through each of the steps S212 to S216 will be affected by the driving signal derived through the previous step, and thus, driving signals for the same data may vary. For example, when the second data of the first image data substantially equals the second data of the second image data and the first data of the first image data substantially differs from the first data of the second image data, the second driving signal of the first image data substantially differs from the second driving signal of the second image data.

As shown in FIG. 5, in the step S22, the driving module can respectively drive the pixel according to the first driving signal, the second driving signal and the third driving signal of the first image data in the first sub-frame time, the second sub-frame time and the third sub-frame time of the first frame time, and then respectively drive the pixel according to the first driving signal, the second driving signal and the third driving signal of the second image data in the first sub-frame time, the second sub-frame time and the third sub-frame time of the second frame time. In detail, the first driving signal, the second driving signal and the third driving signal of the first image data are used to control a first transmittance curve, a second transmittance curve and a third transmittance curve of the pixel, respectively, and the first driving signal, the second driving signal and the third driving signal of the second image data are used to control a fourth transmittance curve, a fifth transmittance curve and a sixth transmittance curve of the pixel, respectively. The first transmittance curve, the second transmittance curve, the third transmittance curve, the fourth transmittance curve, the fifth transmittance curve and the sixth transmittance curve can be variables.

Besides, the light emitting module can provide various colored light according to the image data. For example, the light emitting module can respectively emit a first colored light, a second colored light and a third colored light in the first sub-frame time, the second sub-frame time and the third sub-frame time. The first colored light, the second colored light and the third colored light can be one of red light, green light and blue light and different from each other. In addition, the color of the first colored light corresponds to that of the sub-grey value of the first data, the color of the second colored light corresponds to that of the sub-grey value of the second data, and the color of the third colored light corresponds to that of the sub-grey value of the third data. Here, the first colored light, the second colored light and the third colored light respectively are, for example, red light, green light and blue light, and correspond to the sub-grey value of the first data, the sub-grey value of the second data and the sub-grey value of the third data.

For clearly illustrating the driving method of the first embodiment, the transmittance curve corresponding to the first image data relating to the lighting time of the light emitting module as shown in FIG. 8 will be explained as an example below. Referring to FIG. 8, the first sub-frame time T₂₁, the second sub-frame time T₂₂ and the third sub-frame time T₂₃ are according to the time sequence and each less than a frame time, for example. The integral of the first transmittance curve V₂₁ over the lighting time T₂ₐ of the light emitting module in the first sub-frame time T₂₁ substantially equals the product of the brightness corresponding to the first data G₂₍ₙ₊₁₎ and the first sub-frame time T₂₁. The integral as mentioned above is total brightness received by the human eye in the period T₂ₐ, and the product as mentioned above can conform to the Gamma curve of the display apparatus.

Similarly, the integral of the second transmittance curve V₂₂ (or the third transmittance curve V₂₃) over the lighting time T_{2b} (or the lighting time T_{2c}) of the light emitting module in the second sub-frame time T₂₂ (or the third sub-frame time T₂₃) substantially equals the product of the brightness corresponding to the second data G₂₍ₙ₊₂₎ (or the third data G₂₍ₙ₊₃₎) of the first image data and the second sub-frame time T₂₂ (or the third sub-frame time T₂₃). The integral as mentioned above is total brightness received by the human eye in the period T_{2b} (or the period T_{2c}), and the product as mentioned above can conform to the Gamma curve of the display apparatus.

To improve utility rate of the light emitting module, the light emitting module is turned on during the period in which the transmittance of the first transmittance curve exceeds or equals 10 percent of the maximum transmittance of the first transmittance curve occurring over the first sub-frame time, when the first data (sub-grey value) is lower than or equal to the second data (sub-grey value), i.e., the first transmittance curve turns upwards from the first sub-frame time to the second sub-frame time. This is described in the following equation:

T1(n)>=10%*Max(T1(t=0˜t1))

T1(n) denotes the transmittance value of the first transmittance curve at the beginning of the lighting time of the light emitting module (i.e., at the moment the light emitting module is turned on). T1(t) denotes the first transmittance curve, and t1 denotes the end of the first sub-frame time.

On the contrary, when the first data (sub-grey value) is higher than the second data (sub-grey value), i.e., the first transmittance curve turns downwards from the first sub-frame time to the second sub-frame time, the light emitting module is turned on during the period in which the transmittance of the first transmittance curve is lower than or equals 90 percent of the maximum transmittance of the first transmittance curve occurring over the first sub-frame time. This is described in the following equation:

T1(n)<=90%*Max(T1(t=0˜t1))

Accordingly, when the light emitting module turns on can be dynamically controlled, so the usage of the light emitting module is more efficient. Besides, incorrect displaying, caused by the unstable state of the liquid crystal at the beginning of each sub-frame time, can be avoided, to improve displaying quality and decrease power consumption of the light emitting module.

In addition, the transmittance curve, corresponding to the second image data (including various data, e.g., first through third data) relating to the lighting time of the light emitting module in the second frame time which proceeds after the first frame time, will be familiar by referring to FIG. 8 and the foregoing description, so the detailed description is omitted here.

Furthermore, the liquid crystal of the pixel can be selected according to practical situations, and in the driving method of the first embodiment, the faster responsive liquid crystal is adopted. The faster responsive liquid crystal means the liquid crystal can reach the stable state during any of the first sub-frame time, the second sub-frame time and the third sub-frame time regardless of the sub-grey values of the first, second and third data applied to the pixel during the first, second, and third sub-frame times, respectively. In the embodiment, the driving signal can be calculated correctly according to the grey value correction table L₂₁, so that the backlight module can operate when the liquid crystal is stable or unstable and then the display apparatus can correctly display even during the unstable time of the liquid crystal. Besides, the driving method of the first embodiment does not output the first driving signal or the second driving signal just according to the first data or the second data. In other words, when the second data of the first image data substantially equals the second data of the second image data, and the first data of the first image data substantially differs from the first data of the second image data, the second driving signal of the first image data substantially differs from the second driving signal of the second image data.

Accordingly and taking the first sub-frame time of the first image data as an example to explain, because the integral of the first transmittance curve over the lighting time of the light emitting module in the first sub-frame time substantially equals the product of the brightness corresponding to the first sub-grey value and the first sub-frame time, the display apparatus can correctly display images. In other words, the disclosed embodiments of the invention can turn on the backlight module when the liquid crystal is still unstable by a look-up table or calculation, to achieve sufficient usage of the backlight module. Therefore, the backlight module in the disclosed embodiments of the invention can operate during the stable period and/or the unstable period of the liquid crystal according to practical situations, to enhance the utility rate of the backlight module and increase options of liquid crystal material with different features (such as faster responsive liquid crystal or slower responsive liquid crystal).

### Second Embodiment

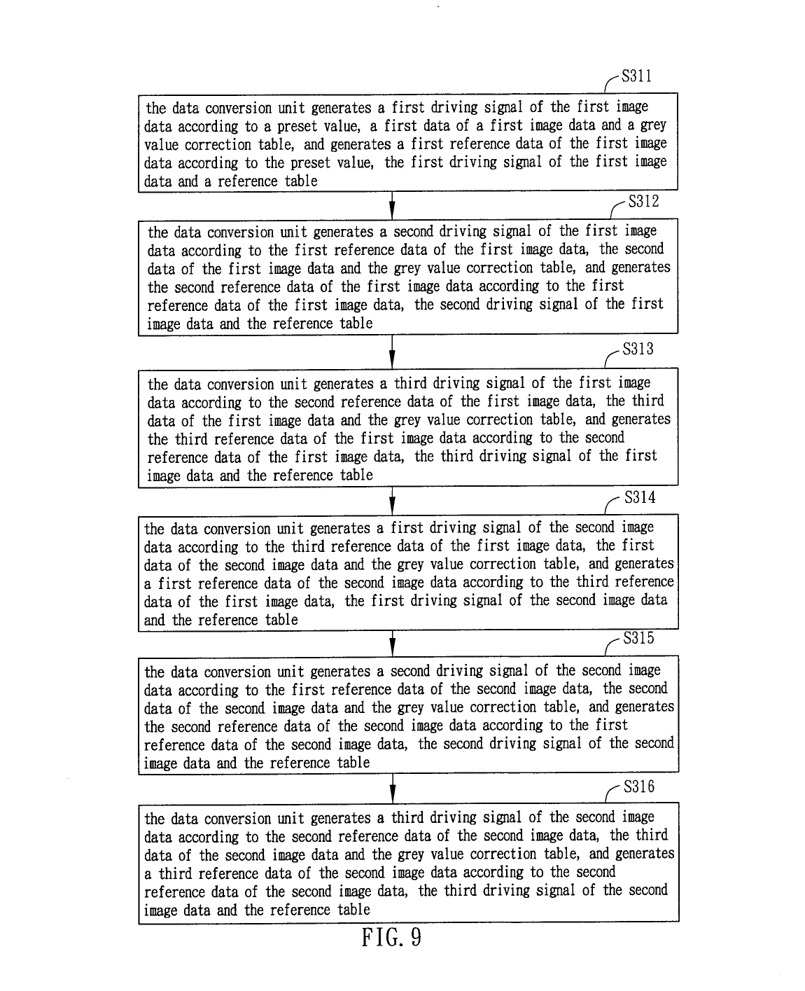

A driving method of a display apparatus according to the second embodiment at least has steps S21 to S22. The step S22 of the second embodiment is the same as that of the first embodiment, so the detailed description is omitted here. The difference between the second embodiment and the first embodiment is that, the step S21 of the second embodiment includes steps S311 to S316 as shown in FIG. 9.

As shown in FIG. 9, in the step S311, the data conversion unit generates a first driving signal of the first image data according to (i) a preset value, (ii) a first data of the first image data, and (iii) a grey value correction table, and generates a first reference data of the first image data according to (iv) the preset value, (v) the first driving signal of the first image data, and (vi) a reference table.

In the step S312, the data conversion unit generates a second driving signal of the first image data according to (i) the first reference data of the first image data, (ii) the second data of the first image data, and (iii) the grey value correction table, and generates a second reference data of the first image data according to (iv) the first reference data of the first image data, (v) the second driving signal of the first image data, and (vi) the reference table.

In the step S313, the data conversion unit generates a third driving signal of the first image data according to (i) the second reference data of the first image data, (ii) the third data of the first image data, and (iii) the grey value correction table, and generates a third reference data of the first image data according to (iv) the second reference data of the first image data, (v) the third driving signal of the first image data, and (vi) the reference table.

In the step S314, the data conversion unit generates a first driving signal of the second image data according to (i) the third reference data of the first image data, (ii) the first data of the second image data, and (iii) the grey value correction table, and generates a first reference data of the second image data according to (iv) the third reference data of the first image data, (v) the first driving signal of the second image data, and (vi) the reference table.

In the step S315, the data conversion unit generates a second driving signal of the second image data according to (i) the first reference data of the second image data, (ii) the second data of the second image data, (iii) and the grey value correction table, and generates a second reference data of the second image data according to (iv) the first reference data of the second image data, (v) the second driving signal of the second image data, and (vi) the reference table.

In the step S316, the data conversion unit generates a third driving signal of the second image data according to (i) the second reference data of the second image data, (ii) the third data of the second image data, and (iii) the grey value correction table, and generates a third reference data of the second image data according to (iv) the second reference data of the second image data, (v) the third driving signal of the second image data, and (vi) the reference table.

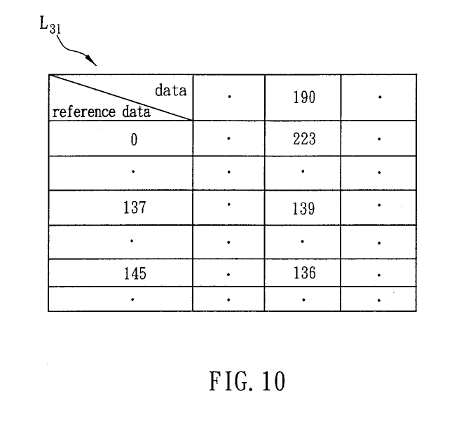

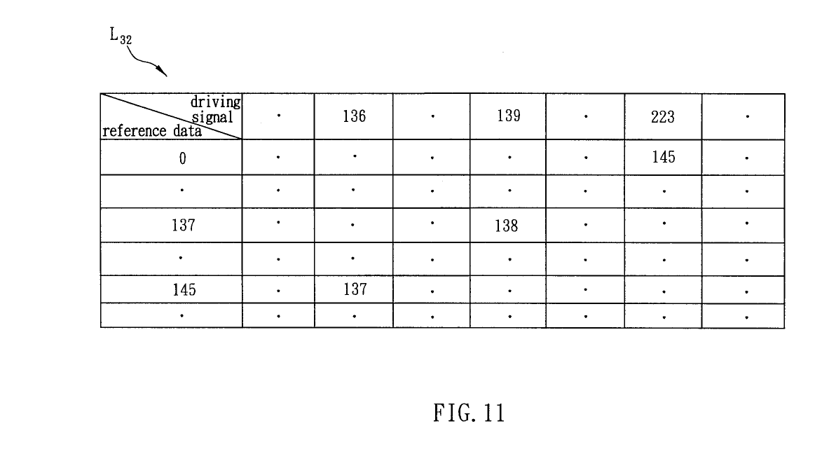

As shown in FIGS. 10 and 11, for example, the first data, the second data and the third data of the first image data are represented by 190, 190 and 190, respectively, and zero is set as the preset value. First, according to the grey value correction table L₃₁, the value 233, as the first driving signal of the first image data, is derived from the preset value (zero) and the first data (190). Besides, according to the reference table L₃₂, the value 145, as the first reference data of the first image data, is derived from the preset value (zero) and the first driving signal (233) of the first image data.

Then, according to the grey value correction table L₃₁, the value 136, as the second driving signal of the first image data, is derived from the first reference data (145) and the second data (190) of the first image data. Besides, according to the reference table L₃₂, the value 137, as the second reference data of the first image data, is derived from the first reference data (145) and the second driving signal (136) of the first image data.

Furthermore, according to the grey value correction table L₃₁, the value 139, as the third driving signal of the first image data, is derived from the second reference data (137) and the third data (190) of the first image data. Besides, according to the reference table L₃₂, the value 138, as the third reference data of the first image data, is derived from the second reference data (137) and the third driving signal (139) of the first image data.

Besides, the first driving signal, the second driving signal and the third driving signal of the second image data, and the first reference data, the second reference data and the third reference data of the second image data can be derived in the same way as mentioned above, so the detailed description is omitted here.

The liquid crystal of the pixel can be selected according to practical situations, and in the driving method of the second embodiment, the slower responsive liquid crystal is adopted. The slower responsive liquid crystal means, at certain sub-grey values of the first, second and/or third data, the liquid crystal may not be able to reach the stable state during the complete first sub-frame time, the complete second sub-frame time and the complete third sub-frame time, respectively.

In the second embodiment, the slower responsive liquid crystal is compensated with the driving signals calculated according to the grey value table L₃₁ and the reference table L₃₂, so that the display apparatus can correctly display even when the backlight module operates during the unstable time of the liquid crystal. Therefore, because the slower responsive liquid crystal is cheaper than the faster responsive liquid crystal, the disclosed embodiments of the invention can save the cost of the liquid crystal, compared with the known driving method that should use the faster responsive liquid crystal.

### Third Embodiment

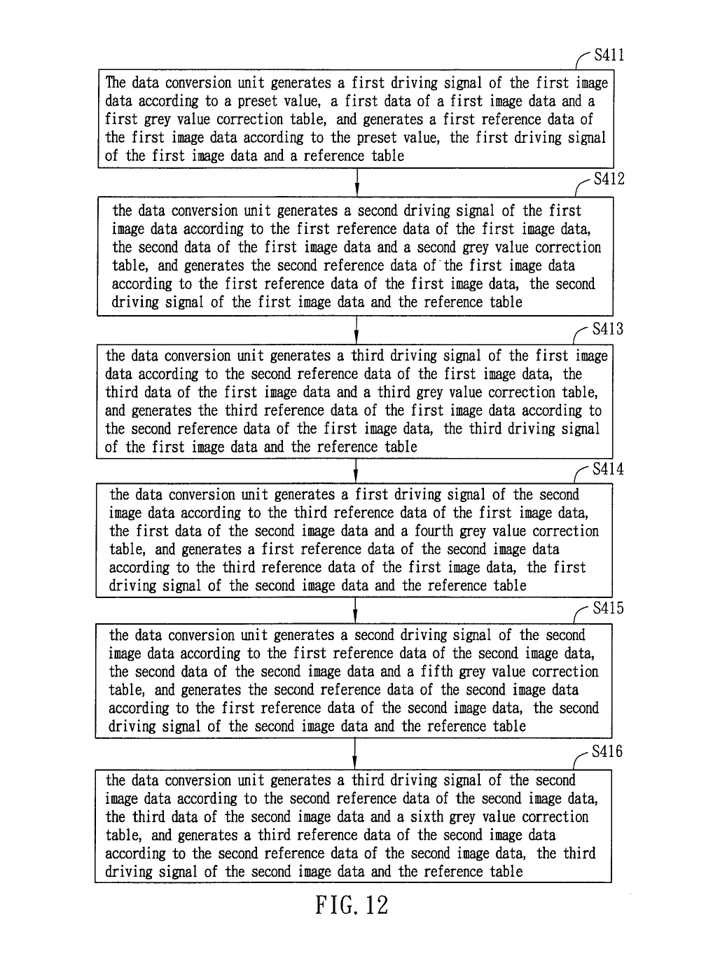

A driving method of a display apparatus according to the third embodiment at least has steps S21 to S22. The step S22 of the second embodiment is the same as that of the first embodiment, so the detailed description is omitted here. The difference between the third embodiment and the first embodiment is that, the step S21 of the third embodiment includes steps S411 to S416 as shown in FIG. 12.

As shown in FIG. 12, in the step S411, the data conversion unit generates a first driving signal of the first image data according to (i) a preset value, (ii) a first data of the first image data, and (iii) a first grey value correction table, and generates a first reference data of the first image data according to (iv) the preset value, (v) the first driving signal of the first image data, and (vi) a reference table.

In the step S412, the data conversion unit generates a second driving signal of the first image data according to (i) the first reference data of the first image data, (ii) the second data of the first image data, and (iii) a second grey value correction table, and generates a second reference data of the first image data according to (iv) the first reference data of the first image data, (v) the second driving signal of the first image data, and (vi) the reference table.

In the step S413, the data conversion unit generates a third driving signal of the first image data according to (i) the second reference data of the first image data, (ii) the third data of the first image data, and (iii) a third grey value correction table, and generates a third reference data of the first image data according to (iv) the second reference data of the first image data, (v) the third driving signal of the first image data, and (vi) the reference table.

In the step S414, the data conversion unit generates a first driving signal of the second image data according to (i) the third reference data of the first image data, (ii) the first data of the second image data, and (iii) a fourth grey value correction table, and generates a first reference data of the second image data according to (iv) the third reference data of the first image data, (v) the first driving signal of the second image data, and (vi) the reference table.

In the step S415, the data conversion unit generates a second driving signal of the second image data according to (i) the first reference data of the second image data, (ii) the second data of the second image data, and (iii) a fifth grey value correction table, and generates a second reference data of the second image data according to (iv) the first reference data of the second image data, (v) the second driving signal of the second image data, and (vi) the reference table.

In the step S416, the data conversion unit generates a third driving signal of the second image data according to (i) the second reference data of the second image data, (ii) the third data of the second image data, and (iii) a sixth grey value correction table, and generates a third reference data of the second image data according to (iv) the second reference data of the second image data, (v) the third driving signal of the second image data, and (vi) the reference table.

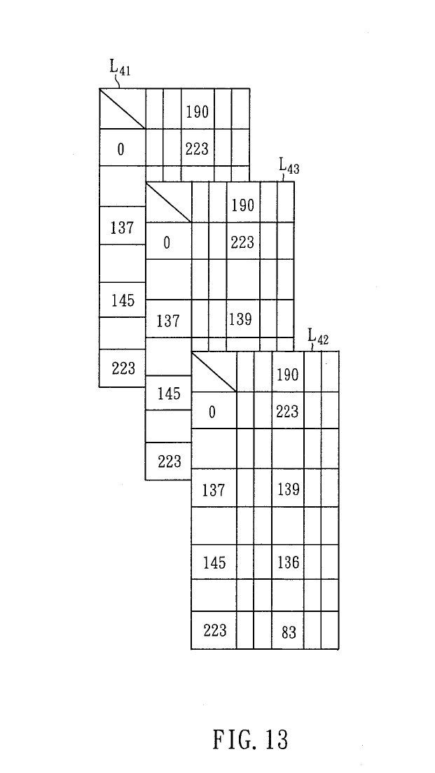

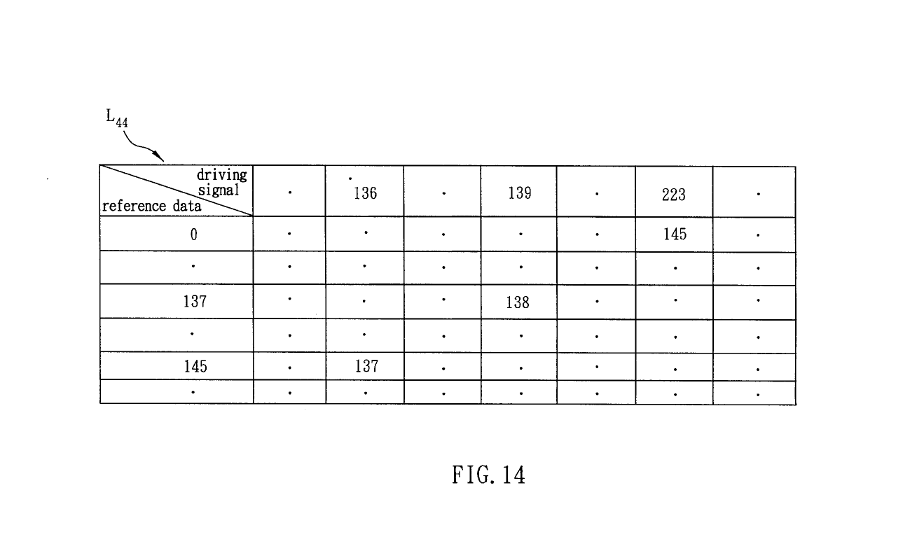

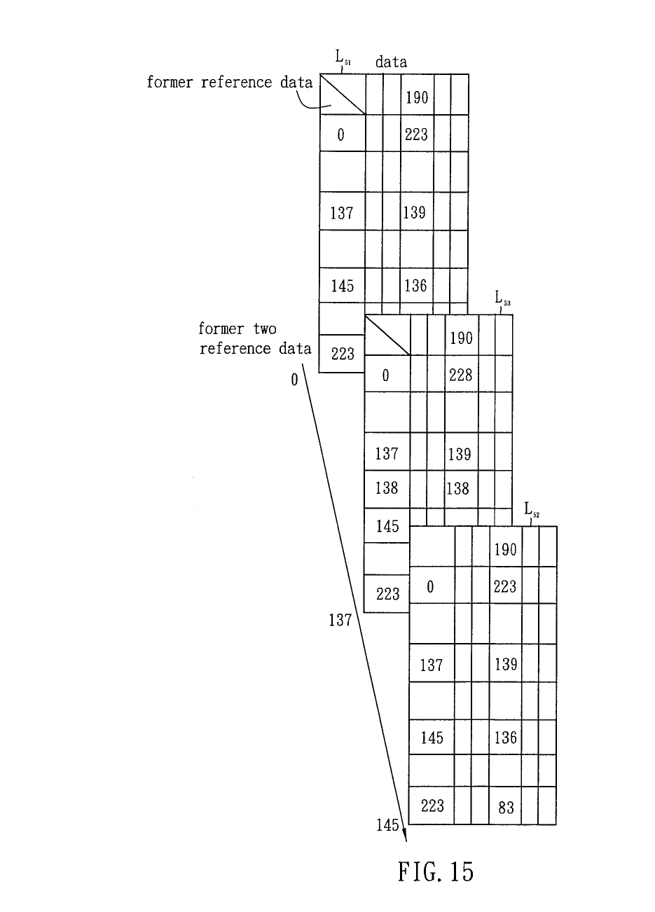

As shown in FIGS. 13 and 14, for example, the first data, the second data and the third data of the first image data are represented by 190, 190 and 190, respectively, and zero is set as the preset value. First, according to the first grey value correction table L₄₁, the value 233, as the first driving signal of the first image data, is derived from the preset value (zero) and the first data (190) of the first image data. Besides, according to the reference table L₄₄, the value 145, as the first reference data of the first image data, is derived from the preset value (zero) and the first driving signal (233) of the first image data.

Then, according to the second grey value correction table L₄₂, the value 136, as the second driving signal of the first image data, is derived from the first reference data (145) and the second data (190) of the first image data. Besides, according to the reference table L₄₄, the value 137, as the second reference data of the first image data, is derived from the first reference data (145) and the second driving signal (136) of the first image data.

Furthermore, according to the third grey value correction table L₄₃, the value 139, as the third driving signal of the first image data, is derived from the second reference data (137) and the third data (190) of the first image data. Besides, according to the reference table L₄₄, the value 138, as the third reference data of the first image data, is derived from the second reference data (137) and the third driving signal (139) of the first image data.

Besides, the first driving signal, the second driving signal and the third driving signal of the second image data, and the first reference data, the second reference data and the third reference data of the second image data can be derived in the same way as mentioned above, so the detailed description is omitted here.

In FIG. 13, the first grey value correction table L₄₁, the second grey value correction table L₄₂ and the third grey value correction table L₄₃ are designed in similar standard. Of course, they can be variously designed according to the size of the reference data. For example, considering the third-order effect caused by the liquid crystal, i.e., the third transmittance curve (corresponding to the third driving signal and the third reference data) is affected not only by the second transmittance curve (corresponding to the second reference data) but also by the first transmittance curve (corresponding to the first reference data), the grey value correction table can be designed according to the previous two driving signals.

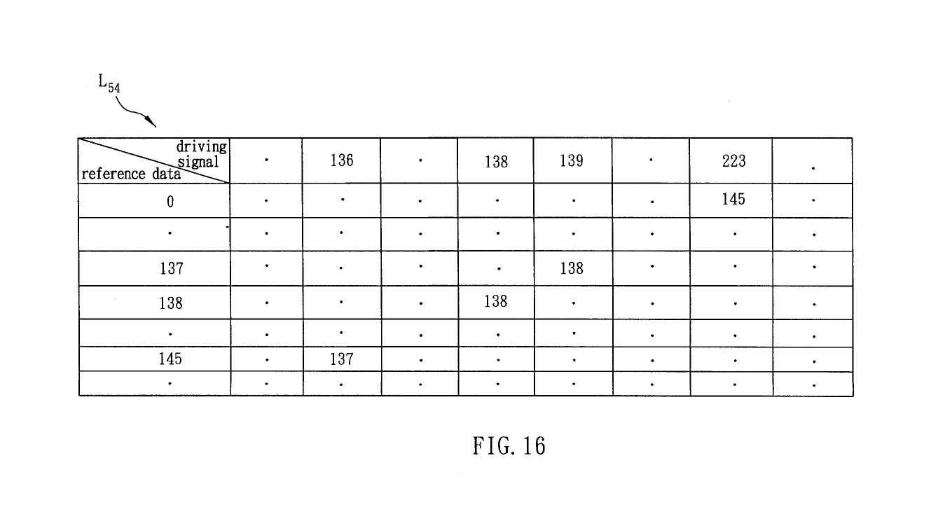

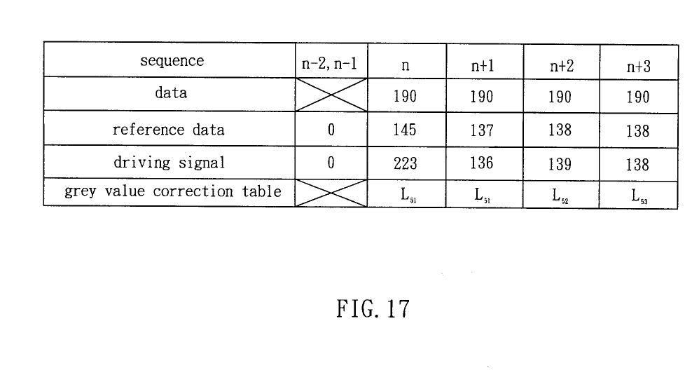

For example, referring to FIGS. 15 to 17, the n^{th} data, (n+1)^{th} data, (n+2)^{th} data and (n+3)^{th} data are represented by 190, 190, 190 and 190, respectively. First, the first grey value correction table L₅₁ is determined to be used according to the (n−2)^{th} reference data (preset as zero). The value 233, as the n^{th} driving signal, can be derived from the n^{th} data and (n−1)^{th} reference data (preset as zero) according to the first grey value correction table L₅₁. Besides, the value 145, as the n^{th} reference data, can be derived from the (n−1)^{th} reference data and n^{th} driving signal according to the reference table L₅₄.

Then, the first grey value correction table L₅₁ is determined to be used according to the (n−1)^{th} reference data (preset as zero). The value 136, as the (n+1)^{th} driving signal, can be derived from the (n+1)^{th} data and n^{th} reference data according to the first grey value correction table L₅₁. Besides, the value 137, as the (n+1)^{th} reference data, can be derived from the n^{th} reference data and (n+1)^{th} driving signal according to the reference table L₅₄.

Furthermore, the second grey value correction table L₅₂ is determined to be used according to the n^{th} reference data. The value 139, as the (n+2)^{th} driving signal, can be derived from the (n+2)^{th} data and (n+1)^{th} reference data according to the second grey value correction table L₅₂. Besides, the value 138, as the (n+2)^{th} reference data, can be derived from the (n+1)^{th} reference data and (n+2)^{th} driving signal according to the reference table L₅₄.

Last, the third grey value correction table L₅₃ is determined to be used according to the (n+1)^{th} reference data. The value 138, as the (n+3)^{th} driving signal, can be derived from the (n+3)^{th} data and (n+2)^{th} reference data according to the third grey value correction table L₅₃. Besides, the value 138, as the (n+3)^{th} reference data, can be derived from the (n+2)^{th} reference data and (n+3)^{th} driving signal according to the reference table L₅₄.

The liquid crystal of the pixel can be selected according to practical situations, and in the driving method of the third embodiment the slower responsive liquid crystal is adopted. The slower responsive liquid crystal has been defined herein.

In the third embodiment, the slower responsive liquid crystal is compensated with the driving signals calculated according to the grey value tables L₄₁, L₄₂ and L₄₃ and the reference table L₄₄. Besides, the driving signals calculated according to the grey value tables L₄₁, L₄₂ and L₄₃ and the reference table L₄₄ can also compensate for the third transmittance curve (corresponding to the third data) affected by the first transmittance curve (corresponding to the first data) and the second transmittance curve (corresponding to the second data), to make the display apparatus correctly display even when the backlight module operates during the unstable period of the liquid crystal to save the cost of the liquid crystal.

### Fourth Embodiment

A display apparatus to which the foregoing driving methods can be applied will be described below.

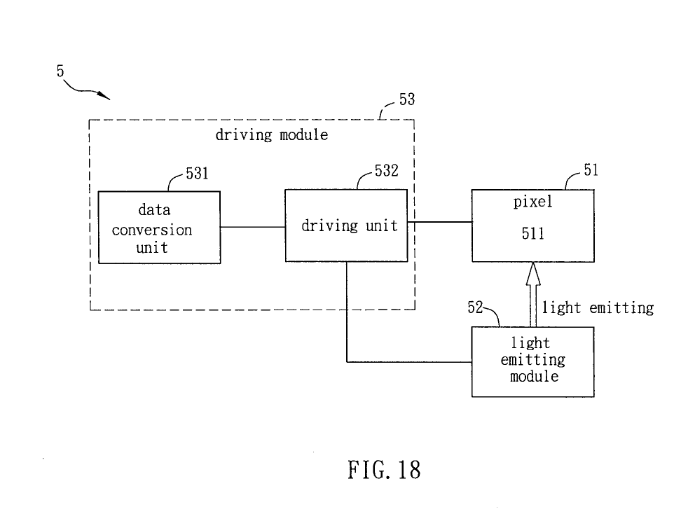

As shown in FIG. 18, a display apparatus 5, such as a liquid crystal display (LCD) apparatus, at least includes at least a pixel 51, a light emitting module 52 and a driving module 53. The pixel 51 is disposed adjacent to the light emitting module 52. In the embodiment, the pixel 51 at least has liquid crystal 511, and the light emitting module 52 can be a backlight module.

The operation of the light emitting module 52 is illustrated in the driving methods of the display apparatus according to the first, second and third embodiments, so the detailed description is omitted here.

Besides, the driving module 53 has a data conversion unit 531 and a driving unit 532 which is electrically connected with the data conversion unit 531 and the pixel 51, respectively. In the fourth embodiment, the data conversion unit 531 is a timing controller (T-CON). The data conversion unit 531 can output a first driving signal, a second driving signal and a third driving signal of the first image data according to the first data, the second data and the third data of the first image data, respectively, and output a first driving signal, a second driving signal and a third driving signal of the second image data according to the first data, the second data and the third data of the second image data, respectively. The first driving signal, the second driving signal and the third driving signal are generated by the data conversion unit 531 as discussed above in the driving methods of the display apparatus according to the first, second and third embodiments, so the detailed description is omitted here. Besides, the foregoing tables can be generated in real time, or stored beforehand in a register of the data conversion unit 531 or in an independent register.

The driving unit 532 can be a data line driving circuit or a scan line driving circuit. Because the driving unit 532 is a known device, the detailed description is omitted here.

In summary, in the display apparatus and the driving method thereof according to disclosed embodiments of the invention, because the integral of the first transmittance curve (or the second transmittance curve or the third transmittance curve) over the lighting time of the light emitting module in the first sub-frame time (or the second sub-frame time or the third sub-frame time) substantially equals the product of the brightness corresponding to the first data (or the second data or the third data) and the first sub-frame time (or the second sub-frame time or the third sub-frame time), the display apparatus can correctly display images. Accordingly, the backlight module in disclosed embodiments of the invention can be turned on during the stable period and/or the unstable period of the liquid crystal, thereby enhancing the utility rate of the backlight module and increasing options of liquid crystal material with different features (such as faster responsive liquid crystal or slower responsive liquid crystal).

Although exemplary embodiments of the invention have been described, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the scope of the invention.

1. A display apparatus for sequentially display images in accordance with first data and second data in successive first and second sub-frame times, respectively, said apparatus comprising:
at least one pixel;
a light emitting module for emitting light to the pixel in the sub-frame times; and
a driving module, comprising:
a data conversion unit for outputting (i) a first driving signal based on at least the first data, and (ii) a second driving signal based on the first driving signal and the second data; and
a driving unit for (i) driving the pixel in the first sub-frame time according to the first driving signal and (ii) driving the pixel in the second sub-frame time according to the second driving signal.

2. The display apparatus as recited in claim 1, wherein the light emitting module is configured for emitting
light of a first color in the first sub-frame time to cause the pixel to display the first color in accordance with the first data in the first sub-frame time, and
light of a second color differing from the first color in the second sub-frame time to cause the pixel to display the second color in accordance with the second data in the second sub-frame time.

3. The display apparatus as recited in claim 1, wherein the first and second sub-frame times belong to a single frame time.

4. The display apparatus as recited in claim 1, wherein the first and second sub-frame times belong to successive frame times.

5. The display apparatus as recited in claim 1, wherein
the data conversion unit is further configured for outputting a third driving signal based on (a) both the first and second driving signals and (b) third data corresponding to a third sub-frame time which is successive to the second sub-frame time; and
the driving unit is further configured for driving the pixel in the third sub-frame time according to the third driving signal.

6. A display apparatus for sequentially displaying a first image data and a second image data in a first frame time and a second frame time, respectively, wherein the first image data and the second image data each at least have a first data and a second data, and the first frame time and the second frame time each at least have a first sub-frame time and a second sub-frame time corresponding to the respective first and second data, respectively, said apparatus comprising:
at least one pixel;
a light emitting module for emitting a first colored light in each of the first sub-frame time, and emitting a second colored light differing from the first colored light in each of the second sub-frame time; and
a driving module, comprising:
a data conversion unit for outputting a first driving signal and a second driving signal of the first image data according to the first data and the second data of the first image data, respectively, and outputting a first driving signal and a second driving signal of the second image data according to the first data and the second data of the second image data, respectively; and
a driving unit for driving the pixel in the first sub-frame time of the first frame time according to the first driving signal of the first image data, and driving the pixel in the second sub-frame time of the first frame time according to the second driving signal of the first image data, and driving the pixel in the first sub-frame time of the second frame time according to the first driving signal of the second image data, and driving the pixel in the second sub-frame time of the second frame time according to the second driving signal of the second image data,
wherein when the second data of the first image data substantially equals the second data of the second image data, and the first data of the first image data substantially differs from the first data of the second image data, the second driving signal of the first image data substantially differs from the second driving signal of the second image data.

7. The display apparatus as recited in claim 6, wherein the data conversion unit is configured to generate the first driving signal of the first image data at least according to the first data of the first image data and a grey value correction table.

8. The display apparatus as recited in claim 7, wherein the data conversion unit is configured to generate the second driving signal of the first image data according to the second data of the first image data, the first driving signal of the first image data, and the grey value correction table.

9. The display apparatus as recited in claim 7, wherein the data conversion unit is configured to generate a first reference data of the first image data at least according to the first driving signal of the first image data and a reference table.

10. The display apparatus as recited in claim 8, wherein the data conversion unit is configured to generate the second driving signal of the first image data according to the first reference data, the second data of the first image data and the grey value correction table.

11. A driving method of driving a display apparatus, which has at least one pixel, a light emitting module and a driving module, to sequentially display a first image data and a second image data in a first frame time and a second frame time, respectively, wherein the first image data and the second image data each at least have a first data and a second data, the first frame time and the second frame time each at least have a first sub-frame time and a second sub-frame time corresponding to the respective first and second data, respectively, the driving module has a data conversion unit and a driving unit, the method comprising:
outputting a first driving signal and a second driving signal of the first image data according to the first data and the second data of the first image data, respectively, by the data conversion unit;
outputting a first driving signal and a second driving signal of the second image data according to the first data and the second data of the second image data, respectively, by the data conversion unit;
driving the pixel in the first sub-frame time of the first frame time according to the first driving signal of the first image data, and driving the pixel in the second sub-frame time of the first frame time according to the second driving signal of the first image data, by the driving unit; and
driving the pixel in the first sub-frame time of the second frame time according to the first driving signal of the second image data, and driving the pixel in the second sub-frame time of the second frame time according to the second driving signal of the second image data, by the driving unit,
wherein when the second data of the first image data substantially equals the second data of the second image data, and the first data of the first image data substantially differs from the first data of the second image data, the second driving signal of the first image data substantially differs from the second driving signal of the second image data.

12. The driving method as recited in claim 11, further comprising:
generating the first driving signal of the first image data at least according to the first data of the first image data and a grey value correction table, by the data conversion unit.

13. The driving method as recited in claim 12, further comprising:
generating the second driving signal of the first image data according to the second data of the first image data, the first driving signal of the first image data, and the grey value correction table.

14. The driving method as recited in claim 12, further comprising:
generating a first reference data of the first image data at least according to the first driving signal of the first image data and a reference table, by the data conversion unit.

15. The driving method as recited in claim 14, further comprising:
generating the second driving signal of the first image data according to the first reference data, the second data of the first image data and the grey value correction table, by the data conversion unit.

16. A driving method of driving a display apparatus, which at least has a driving module, at least one pixel and a light emitting module, to display a first data in a first sub-frame time, said method comprising:
controlling (i) a first transmittance curve of the pixel at least according to the first data and (ii) a first lighting time of the light emitting module in the first sub-frame time by the driving module, wherein the integral of the first transmittance curve over the first lighting time of the light emitting module in the first sub-frame time substantially equals the product of a first brightness corresponding to the first data and the first sub-frame time.

17. The driving method as recited in claim 16, further comprising driving the display apparatus to sequentially display a second data in a second sub-frame time successive to the first sub-frame time by
controlling (i) a second transmittance curve of the pixel at least according to the second data and (ii) a second lighting time of the light emitting module in the second sub-frame time by the driving module, wherein the integral of the second transmittance curve over the second lighting time of the light emitting module in the second sub-frame time substantially equals the product of a second brightness corresponding to the second data and the second sub-frame time.

18. The driving method as recited in claim 17, further comprising:
turning on the light emitting module to start the first lighting time during a period in which the transmittance of the first transmittance curve exceeds or equals 10 percent of the maximum transmittance of the first transmittance curve occurring over the first sub-frame time, when the first data is lower than or equal to the second data.

19. The driving method as recited in claim 17, further comprising:
turning on the light emitting module to start the second lighting time during a period in which the transmittance of the first transmittance curve is less than or equals 90 percent of the maximum transmittance of the first transmittance curve occurring over the first sub-frame time, when the first data is higher than the second data.

20. The driving method as recited in claim 17, further comprising:
generating a first driving signal at least according to the first data, and controlling the first transmittance curve of the pixel in the first sub-frame time through the first driving signal by the driving module; and.
generating a second driving signal at least according to the first driving signal and the second data, and controlling the second transmittance curve of the pixel in the second sub-frame time through the second driving signal by the driving module.
